(19) United States
(12) Patent Application Publication
(10) Pub. No.: US 2009/0014918 A1
(43) Pub. Date: Jan. 15, 2009

(54) MICROWAVE-ASSISTED PRESS CURE PROCESSING OF FRICTION PADS

(76) Inventors: Yuliu Zheng, Ann Arbor, MI (US); Myron Schmenk, Lambertville, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/775,289

(22) Filed: Jul. 10, 2007

(51) Int. Cl. H05B 6/64

(52) U.S. Cl. 264/432

(57) ABSTRACT

A method and apparatus is provided for forming an in-mold cured brake pad (16). A mold (24) includes sidewalls (28) through which a window (24) made from a generally lossless material such as alumina is formed. Microwaves (42) are directed through the window (46) and into the die cavity (26) of the mold (24) to provide supplemental heating and thereby accelerate the manufacturing cycle time. The friction material composition is tuned by adding an effective quantity of titania or other suitable agent which has the advantage of moving the absorption band for the heat-curable material into the standard band (50) of the microwaves (42) produced by a low-cost magnetron (40), and also of self-regulating the absorption characteristics of the heat-curable material so as to reduce or eliminate the tendency to thermal runaway.

### CROSS REFERENCE TO RELATED APPLICATIONS

None.

### BACKGROUND OF THE INVENTION

1. Field of the Invention

The invention relates generally to the forming of heat-cured work parts inside of a compression forming mold with the aid of microwaves, and more particularly toward methods and apparatus for forming in-mold cured brake pads under the combined influence of conductive and microwave heating modes.

2. Related Art

Many products are manufactured from a heat-curable material which, prior to curing, is formed in a die cavity. One example of the many different types of work parts which are manufactured in this manner may be found in brake pads and brake shoes such as used in the friction brake field of use. In the case of disc brake applications, it is well-known that a plate-like rotor rotates with the wheel of a motor vehicle. Friction pads, made of an abradable material, are held in a caliper on either side of the rotating disc. When an operator of the motor vehicle actuates the braking system, the brake pads are squeezed on opposite sides of the rotating disc, converting dynamic energy into heat which is rejected to the atmosphere. The abradable portion of the friction pads is typically made from a heat-cured material composition affixed to a rigid metallic backing plate.

Manufacturers of heat-cured work parts are always receptive to new methods for manufacturing their products more economically. Accordingly, there exists a strong interest to improve process productivity by reducing cycle time, that is the time required to produce a heat-cured work part. Generally speaking, two approaches have been pursued to achieve the goal of reduced cycle time in the manufacture of heat-cured work parts. One approach is to select or develop a chemical resin binder that is capable of curing more rapidly and/or at lower heat settings. The other approach is to accelerate the curing step by using more efficient heating methods.

Various prior art attempts have been directed toward the pursuit of more efficient heating methods. Traditionally, at least in the field of brake friction pad manufacture, the heat-curable resin intermixed with the other ingredients of the friction material was either cured in the forming press through conduction heating, or else transferred to a sintering oven after pressing for batch cure processing. The in-press curing method, which relied exclusively on conduction heating, was slow. Cycle times were quite long within the context of large-scale production environments. Conversely, the batch cure technique, in which batches of brake pads are cured in an oven after pressing, introduces an additional step in the manufacturing sequence and requires additional capital investment and processing management to properly execute.

More recently, there have been prior art attempts to accelerate curing through the use of more efficient heating methods by employing hybrid techniques which combine the traditional convection heating methods with microwave heating techniques. For example, U.S. Publication No. 2005/0184434 to R. Akopyan, discloses a combined microwave and conduction heating method of a polymer prior to its injection into a closed mold cavity. In another example, U.S. Pat. No. 5,576,358 assigned to AlliedSignal discloses an in-mold curing technique for brake pads which relies only on microwave heating modes. Other examples have also been proposed.

Accordingly, various prior art approaches aim to achieve more efficient heating of a heat-curable material, such as used in brake friction pads for example. More efficient heating techniques are attractive to manufacturers because traditional conductive heating techniques have proven inefficient to fully heat the core region of the work part due to the relatively low thermal conductivity of such materials. Furthermore, because molding temperatures cannot be too high so as to degrade the outside surfaces of the work part, lower conduction temperatures must be used which naturally increase the required cycle time.

Therefore, there exists a need for a more efficient hybrid heating method in which the traditional conductive heating technique is used but supplemented by microwaves as a secondary heating source. However, any such hybrid heating system will need to address the many issues which have frustrated prior art attempts involving microwaves, including the proper selection of the microwave source so that which is commercially available and relatively inexpensive, the need to excite only the core regions of the work part which are not rapidly heated through the conduction process (i.e., quick and even heat distribution throughout the work part), properly controlling the thermal heating process so as to avoid the well known problem of thermal runaway in microwave heating applications, and finally the practical challenge of integrating the supplemental microwave technique with existing machinery so as to reduce the need for large capital investments in new equipment.

### SUMMARY OF THE INVENTION

The subject invention overcomes the disadvantages and shortcomings of prior art techniques, and addresses all of the necessary issues in implementing a hybrid heating source by providing a mold for forming an in situ, heat-cured work part under the combined influence of conductive and microwave heating modes. The mold of this invention comprises an internal die cavity defined by surrounding walls and a bottom. A press ram is movable within the confines of the walls toward the bottom for compressing the components of a heat-curable work part to shape inside the die cavity. The improvement comprises a generally lossless window directly exposed to the die cavity. The window transmits substantially all of the electromagnetic energy in a microwave-type wave into the die cavity while preventing the escape of heat-curable components from the die cavity during the ram pressing operation.

Thus, the subject mold permits microwaves to pass directly into the die cavity through the lossless window, thereby facilitating hybrid heating techniques and achieving the goal of reducing work part cycle time. This invention is ideally suited for manufacturing brake friction pad and shoe components, however other work parts and material types can be substituted with favorable results.

According to a second aspect of the invention, a method is provided for preventing thermal runaway in a work part made from a heat-curable material during microwave heating. According to this aspect of the invention, the method comprises the steps of preparing a heat-curable material consisting essentially of organic, inorganic and metallic solids suspended in a heat-curable resin binder. The method includes loading the heat-curable material into a die cavity having side walls forming a defined work part shape. The method goes on to include the step of conforming the heat-curable material to the shape of the die cavity under the press of a ram. Then, the heat-curable material is exposed to microwaves cycling within a defined frequency range during the conforming step. The improvement is found in the preparing step which includes adding an effective quantity of titania to the heat-curable material so as to reduce or eliminate the tendency to thermal runaway by moving the microwave absorption band of the heat-curable material out of the defined frequency range of the microwaves produced during the exposing step as a function of the temperature of the heat-curable material. In other words, the addition of titania to the heat-curable material has the natural effect of shifting the microwave absorption band out of the frequency range of the microwaves as the temperature of the heat-curable material increases. Therefore, thermal runaway is prevented automatically, whereby continued exposure of the heat-curable material to microwaves will not continue to increase its temperature because the microwave absorption band of the material has been shifted. Thus, the heat-curable material becomes self-regulating in terms of its ability to be excited by the microwaves.

Yet another aspect of the invention is defined as a method for forming an in-mold cured brake pad. According to this aspect of the invention, the method comprises the steps of preparing a friction material compound consisting essentially of organic, inorganic and metallic solids suspended in a heat-curable resin binder. The friction material is loaded into a die cavity having side walls forming a defined work part shape. The friction materials conformed to the shape of the die cavity under the press of a ram. Once conformed to shape, the friction material is exposed to microwaves. According to this aspect of the invention, the improvement comprises a step of passing the microwaves through a generally lossless window in the side wall of the die cavity during the exposing step. Thus, substantially all of the electromagnetic energy in the microwaves is transmitted into the die cavity through the generally lossless window. However, the window also prevents the escape of friction material are from the die cavity during the conforming step, so that the friction material can be shaped under the press of the ram.

### BRIEF DESCRIPTION OF THE DRAWINGS

These and other features and advantages of the present invention will become more readily appreciated when considered in connection with the following detailed description and appended drawings, wherein:

FIG. 1 is a simplified perspective view of a disc brake assembly such as used in motor vehicle braking applications;

FIG. 2 is a perspective view of an exemplary pair of brake pads having abradable friction surfaces manufactured from a heat-curable material and affixed to rigid metallic backing plates;

FIG. 3 is a schematic representation of a mold according to the subject invention including a die cavity formed by side walls and a movable bottom member, together with a press ram for conforming the friction material to shape inside the die cavity;

FIG. 4 is a schematic view as in FIG. 3 showing a sequential step in the conforming operation for pressing the friction material to shape inside the heated die cavity;

FIG. 5 is a schematic view as in FIG. 4 showing a further progression in the conforming step whereby the friction material has achieved a fully conformed condition;

FIG. 6 is a schematic view as in FIG. 5 depicting the step of exposing the friction material to microwaves during the conforming step simultaneously with conductive heating, the friction material being omitted so as to illustrate the microwave propagation through the lossless window and into the die cavity;

FIG. 7 illustrates the next sequential step in the forming operation, wherein the fully cured brake pad is ejected from the die cavity;

FIG. 8 is a fractional, perspective view illustrating a portion of the die cavity in which the generally lossless window forms a side wall in the die cavity preventing the escape of heat-curable material during the ram compressing operation, but enabling microwaves to pass directly inside the die cavity;

FIG. 9 is a graph depicting how the material addition of titania to the material composition of the heat-curable material effects the absorption band of microwave frequency; and

FIG. 10 is another graph depicting the self-regulating nature of the heat-curable material treated with titania which causes the absorption band of the friction material to move out of the standard band of microwaves produced by a magnetron, thereby preventing thermal runaway.

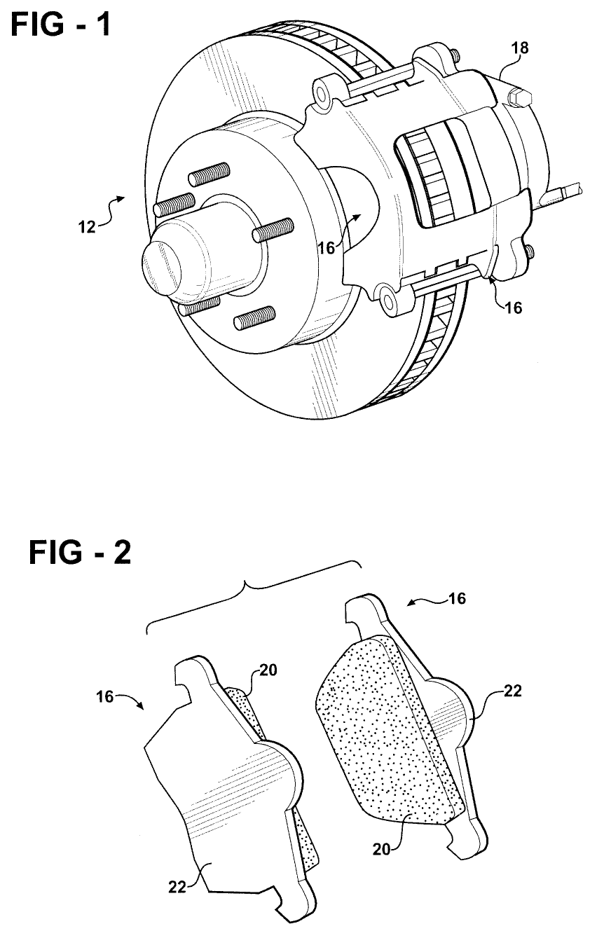

### DETAILED DESCRIPTION OF THE PREFERRED EMBODIMENT

Referring to the Figures, wherein like numerals indicate like or corresponding parts throughout the several views, an exemplary braking system for a motor vehicle is generally shown at 12. This system 12 includes a rotor 14 for a disc brake of a vehicle which rotates together with a wheel (not shown) and has a pair of opposed friction surfaces against which brake pads, generally indicated at 16, are brought into contact to arrest rotation of the wheel. The brake pads 16 are held in a cuff-like caliper 18 which may be actuated through hydraulics, electricity, mechanical linkages, or other known methods.

Throughout the remaining discussion of the subject invention, reference will be made to one preferred application for this invention which is the manufacture of brake pads 16. However, the novel methods and apparatus can be applied to other fields of use wherein heat-curable material is formed and cured to shape inside of a mold. In other words, the invention is not limited to the manufacture of brake pads 16.

As perhaps best shown in FIG. 2, the exemplary brake pads 16 are presented in the fairly conventional form of a friction material 20 which is affixed to a rigid metallic backing plate 22. Various methods have been proposed for uniting the friction material 20 to the back plate 22, such as adhesive, rivets, integral molding, and the like. The method by which the friction material 20 is attached to the back plate 22 is not of primary significance in this invention.

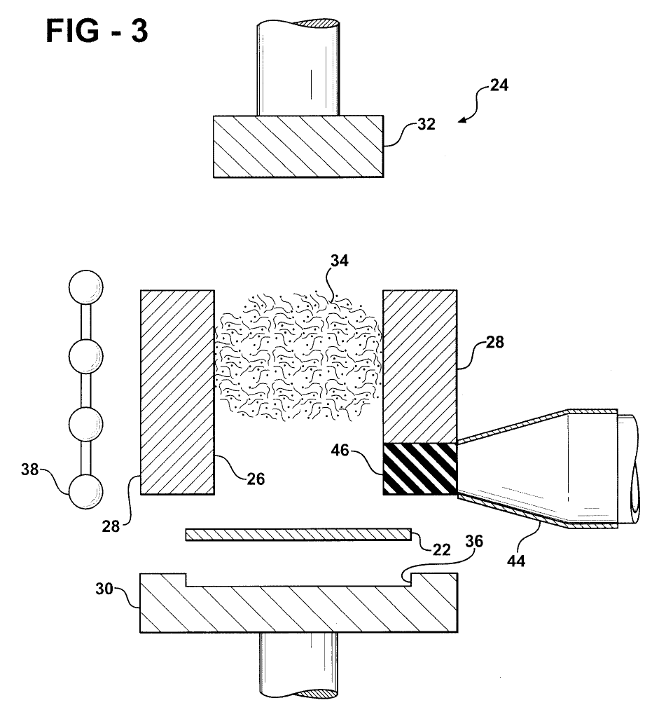

Referring now to FIG. 3, a mold is illustrated for forming an in situ, heat-cured work part (e.g., the brake pad 16) under the combined influence of conductive and microwave heating modes. The mold 24 includes an internal die cavity 26 defined by surrounding walls 28 and a bottom 30. A press ram 32 is movable (relatively speaking) within the confines of the walls 28 toward the bottom 30 for compressing the components 34 of the heat-curable work part to shape inside the die cavity 26. Thus, in the preferred embodiment of this invention, the die cavity forms the shape of the friction material 20 of a brake pad 16 such as illustrated in FIG. 2. The loose collection of components 34 represent the uncured organic, inorganic and metallic solids which are suspended in a heat-curable resin binder, and are loaded as a homogeneous mixture into the die cavity 26.

Typically, but not necessarily, the back plate 22 will be loaded into the die cavity 26 as a loose piece. In the illustrative embodiment of this invention, the bottom 30 is shown including a recess 36 for holding the back plate 22. To facilitate loading and unloading in this example, the die cavity bottom 30 is independently movable relative to the side walls 28.

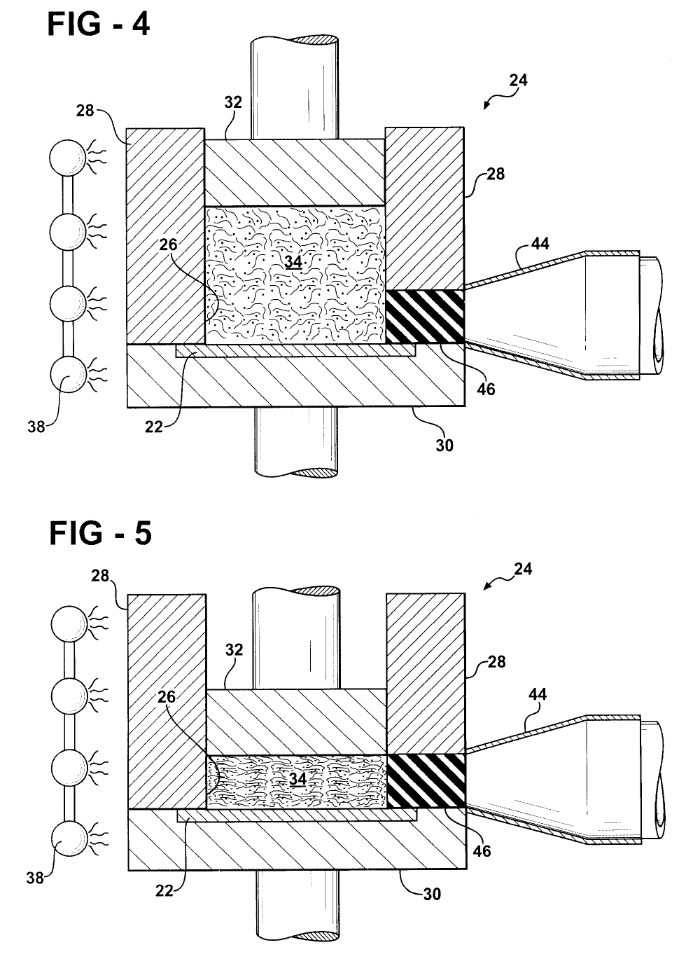

FIG. 4 illustrates the bottom 30 as it is moved into registry with the side walls 28 so as to enclose the lower end of the die cavity 26. The ram 32 closes the open top end of the die cavity 26, thereby trapping the components 34 inside the die cavity 26. Heating elements 38 elevate the temperature of the mold 24 and, through the mechanism of thermal conduction, transfer heat energy into the material components 34. Naturally, the regions of the material components 34 that are in direct contact with the mode sidewalls 28, etc., will be heated first.

FIG. 5 illustrates the conforming step whereby the ram 32 is pressed downwardly toward the bottom 30 so as to compress the components 34 into the size and shape of a finished friction material 20 for a brake pad 16. The heating elements 38 continue to elevate the temperature of the mold 24 to a level at which the chemical resin in the material components 34 begins to cure. Again, the curing propagates inwardly, as heat is conductively transferred through the mold 24 elements and into the material components 34. The core or central region of the compressed components 34 will be the last to experience a temperature increase due to the conductive transmission of heat from the mold 24 elements.

The specific ingredients for the heat-curable components 34 will vary depending upon intended application. As stated previously, in the situation of friction materials 20 for brake pads 16, the heat-curable components 34 are likely to include organic, inorganic and metallic solids suspended in a heat-curable resin binder. However, in other (particularly non-brake-related) applications, the selected components 34 may vary widely. As for this specific material composition of a friction material 20, these ingredients are usually considered to be proprietary formulations which are closely guarded by each manufacturer. The novel features of this invention can be used with many, if not all, of the known formulations. Generally stated, there may be more than 17 different specific ingredients which are varied depending upon the situation, processing conditions, customer demands and other factors. Generally stated, the ingredients required to produce friction material 20 for a brake pad 16 may be selected from the following materials:

| Ingredients | % in Volume |
|---|---|
| Resins | 8% |
| Rubbers | 10% |
| Mineral | 12% |
| Inorganic Fibers | 10% |
| Metal Fiber/Powder | 9% |
| Metal Oxide | 8% |
| Friction Dust | 35% |
| Graphite | 5% |
| Others | 3% |

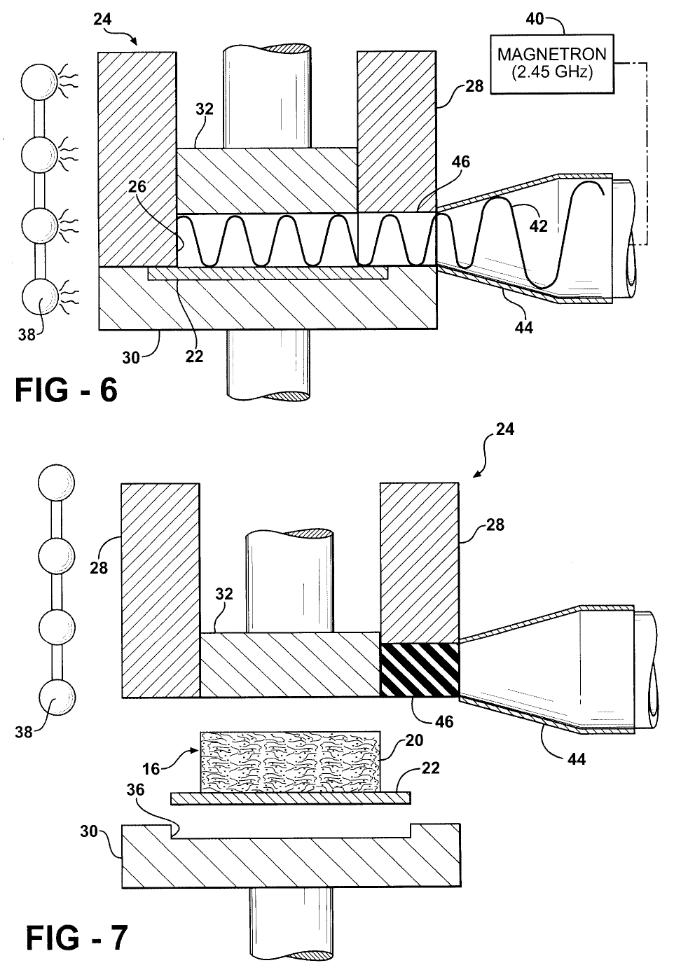

In order to reduce cycle time for in-mold cured work parts, the conductive heat mechanism supplied by the heating elements 38 is supplemented with a microwave heating mode. This is perhaps best depicted in FIG. 6, where a magnetron 40 is energized to produce a microwave type wave form 42 which is directed into the die cavity 26 so as to excite the heat-curable components 34. Although many different types of magnetrons 40 can be purchased on the open market, those operating in the 2.45 GHz range (used in home microwave oven applications) are most readily available and least expensive. In other words, while magnetrons 40 for industrial and educational uses can be found to operate in different frequency ranges, that preferred for use by the subject invention operates within a standard band frequency range of about 2.4-2.5 GHz.

The output of the magnetron 40 is operatively associated with a transition wave guide 44 for directing the microwave-type wave 42 into the die cavity 26. More specifically, the transition wave guide 44 leads to a generally lossless window 46 that is directly exposed to the internal die cavity 26. The window 46 enables substantially all of the transmission of electromagnetic energy in the microwave-type wave 42 to enter the die cavity 26 while preventing the escape of heat-curable components 34 from the die cavity 26 during the ram 32 pressing operation. In other words, the window 46 and the sidewalls 28 together define and contain the components 34 as they are pressed and squeezed into shape by the press ram 32. However, the generally lossless window 46 forms that portion of the otherwise solid sidewalls 28 to which to transition wave guide 44 is attached so that microwaves 42 can pass directly into the compressed friction material without being reflected or otherwise diminished by the mold sidewalls 28. Those of skill in the art will envision other placements for the window 46, such as through the bottom 30 or perhaps through the ram 32. In this preferred embodiment of the invention, however, the window 46 is located in a relatively stationary sidewall 28, due to the fact that both the ram 32 and bottom 30 are moving elements during the loading, pressing and unloading steps of the molding sequence.

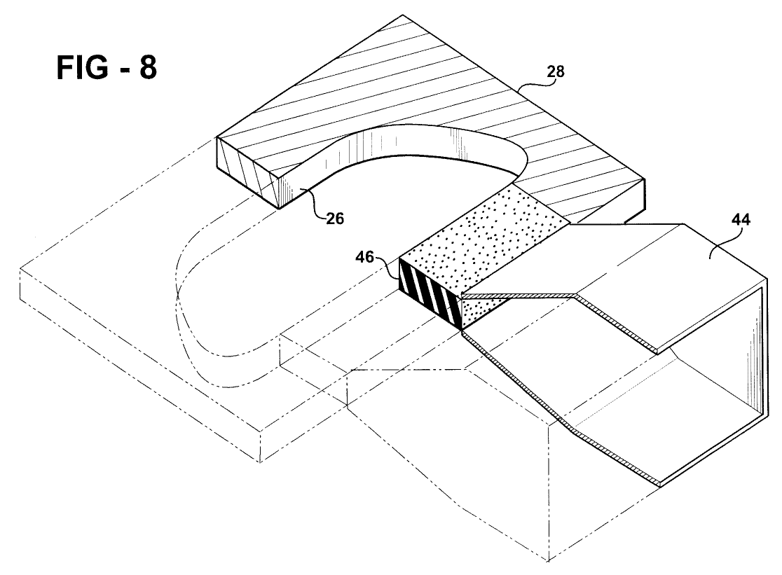

As illustrated in FIG. 8 the window 46 extends continuously between the die cavity 26 and the transition wave guide 44. Acceptable results have been achieved by fabricating the window 46 from a ceramic material, and more particularly an alumina-based material. However, those of skill in the field will no doubt appreciate other lossless materials of sufficient integrity and rigidity to withstand the pressures encountered during the conforming step of operation. Also in FIG. 8, the general shape and construction of the transition wave guide 44 is depicted as having a mostly rectangular cross section as taken in planes transverse to the propagation of electromagnetic waves 42 therethrough. The generally rectangular cross-section of the wave guide 42 then tapers downwardly toward the window 46, and thereby efficiently transitions the microwaves 42 into the die cavity, as best shown in FIG. 6.

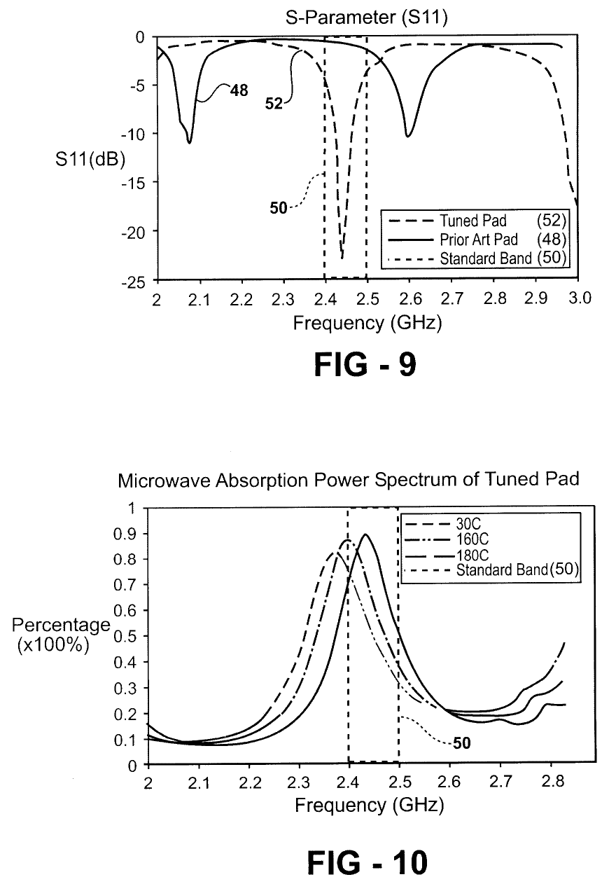

In the production of some heat-curable materials such as friction materials 20 for brake pads 16, it has been found that the normal composition of ingredients is not readily responsive to microwave heating within the standard band frequency (2.4-2.5 GHz) produced by the low cost magnetrons 40 developed for home oven applications. In other words, it may be desirable to “tune” the composition of the components 34 to increase their receptivity to the microwaves 42 during the curing operation. It has been found that the addition of a suitable tuning agent to the ingredient composition has the effect of shifting the absorption band of the friction material components 34 into the frequency range of the microwaves 44 emitted by the low cost magnetron 40. FIG. 9 depicts a graph in which the absorption band of a prior art style friction pad material is represented by line 48. Strong absorption bands are represented in the 2.0-2.1 and again in the 2.55-2.65 frequency ranges. As described previously, these absorption bands are outside the standard band produced by a low-cost, readily available magnetron 40. The standard band is represented by the boxed area 50 bounded by the frequency range of 2.4-2.5 GHz. A standard, readily available and low-cost magnetron 40 is tuned to produce microwaves 42 at about 2.45 GHz. By adding an effective quantity of tuning agent to the heat-curable material components 34, the absorption band of the friction material components 34 can be shifted into this standard band 50, as represented by dashed line 52 in FIG. 9. Thus, the addition of an effective quantity of the suitable tuning agent can be seen to have a dramatic effect on the absorption band for the heat-curable material components 34. As a result, the cycle time can be substantially reduced because the friction material will respond readily to microwaves 42 cycling within a frequency range defined by the standard band 50.

Not only does the addition of a suitable tuning agent help “tune” the friction material components 34 so as to be more readily receptive to the microwave heating step, it has also been found that the addition of the tuning agent produces an especially desirable self-regulating quality which reduces or eliminates the tendency to thermal runaway. Thermal runaway has been defined as the abrupt and localized rise in temperature which is usually caused by a material which becomes more receptive to microwave heating as its temperature increases. This phenomenon has been experienced by most people in home oven heating situations, where a food item heated inside a microwave oven exhibits localized areas which have been over-heated while other areas of the food item are under-heated. This phenomenon can be due, in part, to the tendency for thermal runaway in some materials subject to microwave heating.

The applicant has found that the material titania can serve as a suitable tuning agent. The addition of titania to the ingredients used to form the components 34 has the effect of moving the microwave absorption band of the heat-curdle material out of the defined frequency range of the microwaves produced during the exposing step as the temperature of the components 34 increases. This is perhaps best illustrated in FIG. 10, wherein the standard band 50 is again illustrated as the frequency range between about 2.4 and 2.5 GHz. At 30° C., the microwave absorption power of the material components 34 treated with titania is shown to peak within the standard band 50. Thus, the components 34 readily absorb, and are heated by the microwaves 42 at this low temperature. However, as the temperature increases to 160° C., and then again to 180° C., both temperatures within the curing temperature of friction material pads, the peak absorption power shifts outside of the standard band 50. Thus, as the microwaves 42 act upon the heat-curable material components 34 inside the die cavity 26, the heating effects of the microwaves diminish as a function of the temperature of the heat-curable material. This has the desirable quality of enabling the heat-curable material to quickly rise to a curing temperature, but then to avoid thermal runaway by naturally moving the microwave absorption band of the heat curable material out of the defined frequency range of the microwaves 42, i.e., the standard band 50. Thus, titania has been formed to provide a self-regulating quality in terms of microwave-induced temperature rise.

Although the effective quantity of titania will vary from one application to another, it has been found, at least within the specific field of manufacturing brake pads 16, that an effective quantity of titania will include mixing more than zero but less than about 6 volume percent of titania to the ingredients comprising the heat curable material components 34. In this mixing step, it is generally considered advisable to randomly disperse the titania throughout the heat-curable material components 34 in a thorough (i.e., homogeneous) mixing operation. Titania is likely just one of a wide range of materials that can be used as suitable tuning agents. For example, the mixed valence oxides (e.g., Fe₃O₄, Co₂O₃, CuO, NiO), the sulfide semiconductors (e.g., PbS, FeS₂, CuFeS₂), the various forms of carbon (e.g., lampblack, graphite, carbon fiber), and many other similar materials are all easily heated by microwaves and may possess the desired coupling characteristics to form suitable tuning agents.

Accordingly, the subject invention represents a more efficient hybrid heating method, in which microwaves 42 are used as a secondary heating source, together with the traditional conductive heating such as provided by conductive heating elements 38. The application overcomes many of the issues commonly encountered such as proper selection of the microwave source (magnetron 40), efficient coupling of the magnetron 40 into the loaded cavity 26 via a transition wave guide 42, proper mode shaping via the addition of titania or other suitable tuning agent, excitation of the needed zones (i.e., core region of the die cavity 26) to ensure proper heat distribution, adequate thermal control via the addition of titania, and easy integration of the concept to existing manufacturing equipment.

The subject invention thus implements a hybrid heating method to provide more uniform heating within a work part, and at the same time to retain the benefit of traditional conductive heating. The traditional conductive heating is advantageous as a thermal management technique due to its decreased sensitivity to environmental changes. The microwave application techniques of this invention achieve highly predictable and single-mode-dominant heating within the die cavity 26. Thus, the heating mode can be effectively excited by a standard microwave 42 from a low-cost magnetron 40 via its introduction through a generally lossless window 46 from a standard wave guide 44. The lossless window 46 can effectively help shape the heating mode, and thereby quickly heat the cold core region of the compressed components 34 resulting from the slow propagation of thermal conduction through the mold 24 elements. The selection of alumina as a composition for the window 46 meets both the thermal and mechanical requirements as the closure for a mold cavity 26.

Because of the somewhat specialized press machine requirements for making brake pads 16, wherein both the ram 32 and the bottom 30 move during compression, the applicants have found that application of the microwave 42 through the sidewall 28 of the mold 24 is most convenient. However, other arrangements may of course be used, especially in non-brake pad applications of this invention. The addition of the tuning agent titania (or other suitable substance) into the ingredients for the heat-curable components 34 solves numerous unexpected problems. For example, the peak absorption frequency of a given component 34 formula may be above the standard band for industrial heating (2.45 GHz). This peak frequency shifts downward when temperature increases. Consequently, the microwave heating is not effective at low temperature and has the potential to incur thermal runaway at high temperature. Titania has been found to tune the high absorption band of the modified formula into the standard band (FIG. 9) and also to reduce or eliminate thermal runaway (FIG. 10), although alternative materials may exist. Depending upon its volume fraction of the agent titania, the microwave heating rate at high temperature can become self-limiting, so that thermal control in a hybrid heating system is greatly simplified.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A mold for forming an in situ, heat-cured work part under the combined influence of conductive and microwave heating modes, said mold comprising:
an internal die cavity defined by surrounding walls and a bottom;
a press ram movable within the confines of said walls toward said bottom for compressing the components of the heat-curable work part to shape inside said die cavity; and
a generally lossless window directly exposed to said die cavity, said window for transmitting substantially all of the electromagnetic energy in a microwave type wave into said die cavity while preventing the escape of heat-curable components from said die cavity during the ram compressing operation.

2. The mold of claim 1 wherein said window is disposed in said sidewall of said die cavity.

3. The mold of claim 1 further including a transition wave guide operatively adjoining said window external of said die cavity.

4. The mold of claim 3 wherein said transition wave guide has a generally rectangular cross section taken in a plane transverse to the propagation direction of electromagnetic waves there through.

5. The mold of claim 3 further including a magnetron operatively associated with said transition wave guide for directing an electromagnetic wave toward said window.

6. The mold of claim 1 wherein said bottom of said die cavity is independently movable relative to said sidewall.

7. The mold of claim 6 where in said bottom includes a recess for holding a removable back plate.

8. The mold of claim 1 wherein said window is fabricated from a ceramic material.

9. The mold of claim 1 wherein said window is fabricated from an alumina-based material.

10. A method for preventing thermal runaway in a work part made from a heat-curable material during microwave heating, said method comprising the steps of:
preparing a heat curable material consisting essentially of solids suspended in a heat-curable resin binder;
loading the heat-curable material in a die cavity having sidewalls forming a defined work part shape;
conforming the heat-curable material to the shape of the die cavity under the press of a ram;
exposing the heat-curable material to microwaves cycling within a defined frequency range during said conforming step; and
said preparing step including adding an effective quantity of a tuning agent to the heat-curable material, wherein the tuning agent is selected from the group consisting of: titania, Fe₃O₄, Co₂O₃, CuO, NiO, PbS, FeS₂, CuFeS₂, lampblack, graphite and carbon fiber.

11. The method of claim 10 wherein said step of adding an effective quantity of tuning agent includes mixing more than zero but less than about six volume percent of the tuning agent to the heat-curable material.

12. The method of claim 10 wherein said step of adding an effective quantity of tuning agent includes randomly dispersing the tuning agent throughout the heat-curable material.

13. The method of claim 10 wherein said step of exposing the heat-curable material to microwaves includes passing the microwaves through a window made from a generally lossless material.

14. The method of claim 10 further including the step of removing a finished work part from the die cavity.

15. The method of claim 10 further including the step of transferring heat energy to the heat-curable material through the sidewalls of the die cavity during said conforming step.

16. A method for forming an in-mold cured brake pad, said method comprising the steps of:
preparing a friction material compound consisting essentially of organic, inorganic and metallic solids suspended in a heat-curable resin binder;
loading the friction material in a die cavity having sidewalls forming a defined work part shape;
conforming the friction material to the shape of the die cavity under the press of a ram;
exposing the friction material to microwaves during said conforming step; and
said exposing step including passing the microwaves through a generally lossless window in the sidewall of the die cavity for transmitting substantially all of the electromagnetic energy in the microwaves into the die cavity while preventing the escape of the friction material from the die cavity during said conforming step.

17. The method of claim 16 further including the step of loading a rigid metallic back plate into the die cavity prior to said conforming step.

18. The method of claim 16 wherein said preparing step includes adding an effective quantity of a tuning agent to the friction material compound, wherein the tuning agent is selected from the group consisting of: titania, Fe₃O₄, Co₂O₃, CuO, NiO, PbS, FeS₂, CuFeS₂, lampblack, graphite and carbon fiber.

19. The method of claim 16 further including the step of conductively transferring heat energy to the friction material compound through the sidewalls of the die cavity during said conforming step.

20. The method of claim 16 further including the step of removing a finished brake pad from the die cavity.
